(19) United States
(12) Patent Application Publication
(10) Pub. No.: US 2006/0050461 A1
(43) Pub. Date: Mar. 9, 2006

(54) Method and device for actuating a power circuit breaker

(76) Inventors: Stephan Bolz, Pfatter (DE); Rainer Knorr, Regensburg (DE); Gunter Lugert, Regensburg (DE)

Correspondence Address: LERNER AND GREENBERG, PA, P O BOX 2480, HOLLYWOOD, FL, 33022-2480, US

(21) Appl. No.: 10/531,123

(22) PCT Filed: Sep. 17, 2003
(86) PCT No.: PCT/DE03/03090

§ 371 Date: Oct. 13, 2005

(30) Foreign Application Priority Data
Oct. 9, 2002 (DE) 10247111.8

(51) Int. Cl. H02H 5/04

(52) U.S. Cl. 361/103

(57) ABSTRACT

The invention relates to a method for actuating a semiconductor power switch, by which means the resistance of the switching path (E-A) of the semiconductor power switch is controlled by a control voltage (Vst) in such a way that the chip temperature (T1ist, T2ist) of the power switch (S1, S2) does not exceed a pre-determined nominal value (Tsoll). When the nominal temperature (Tsoll) is reached, the resistance of the switching path (E-A) is increased. The invention also relates to a device for carrying out said method, said device using a transfer gate (TG) controlled by a charge pump (LP) as a semiconductor power switch. Commercially available transistors comprising integrated temperature sensors are used in the transfer gate (TG) as semiconductor power switchs.

The invention relates to a method for actuating a power switch according to the preamble of Claim 1, in particular a semiconductor power switch arranged between two energy storage devices in a wiring system of the vehicle equipped with an integrated starter generator. It also relates to a device for implementing said method according to Claim 2.

In a wiring system of the vehicle with ISG, switching processes are necessary between the energy storage devices—accumulators of different nominal voltages and capacitors (intermediate circuit capacitors, double layer capacitors)—via static frequency changers or switching regulators by means of power switchs which are carried out on the commands of a control unit. A requirement in this case is that before a switch is opened, the switch current flowing through it is brought to 0 A and that before a switch is closed, the switch voltage between its switching contacts is brought to 0V so that the switch can be actuated in a zero-power state. A switch current 0 A can be implemented, for example, by disabling an AC/DC static frequency changer or a DC/DC switching regulator and causes no problem in practice. Regulation to the 0V switch voltage, i.e. no potential difference between the poles of the (opened=non-conductive) switch, usually takes place by deliberately reversing the charge of one of the energy storage devices, for example, an intermediate circuit capacitor, since this is usually the smaller of the energy storage devices. In principle, this regulation can also be carried out by means of a static frequency changer or a switching regulator positioned between said static frequency changer and the wiring system of the vehicle.

The intermediate circuit capacitor for example has a capacity of several 10.000 μF, the double layer capacitor for example a capacity of 200 F and the accumulators a capacity of several Ah. The switch voltage to be equalized can be up to a voltage of 60V.

However, determined by the unfavorable ratio of the power of the static frequency changer (e.g. 6 kW) or the switching regulator (e.g. 1 kW) to the energy required for charge equalizing (up to 40 joules), stringent limits have also been set in practice for voltage equalizing.

If now for example, for reasons of reliability and space requirements, semiconductor switches are used as switches, the accuracy of voltage equalizing which can be achieved in this way is not sufficient.

Currents and powers occurring during normal operation require the use of components (capacitors, switches) with very low resistances. In the case of existing voltage differences, the equalizing currents are accordingly high across the switch to be closed. In extreme cases, this leads to a destruction of the semiconductor.

A limitation of the equalizing current flowing through the switch to a safe value requires a current measurement which necessitates a cost-intensive current sensor at the peak of the occurring currents. In addition, the equalizing process cannot be carried out time-optimized because in the case of an excessive switch voltage, the power loss in the switch is high which represents a further possible limitation.

The object of the invention is to create a method and a corresponding device for actuating a semiconductor power switch which functions without a cost-intensive current sensor and in the case of which the transient effect and the closed circuit condition are controlled in such a way that, even in the case of a high voltage difference at the switch, damage to the semiconductor is excluded.

This object is achieved according to the invention by means of a method in accordance with the features of Claim 1 and a device in accordance with the features of Claim 2. A method and a device for switching a semiconductor power switch are proposed in which the outstanding feature is that the resistance of the switching path of the semiconductor power switch is controlled so that the chip temperature of the semiconductor power switch does not exceed a predetermined nominal temperature, in this case, when the predetermined nominal temperature is reached, the resistance of the switching path of the semiconductor power switch is increased, which on the one hand causes the power dissipation to fall and on the other hand lowers the chip temperature as a result of the reduced power dissipation. Advantageous further developments of the invention can be taken from the subclaims.

The inventive method includes the technical theory to control the resistance of the switching path of the semiconductor power switch by a control voltage so that the temperature in the power switch (chip temperature) does not exceed a predetermined value or is held at a constant value, with the control variable acting as a control signal for generating the control voltage.

With an arrangement for executing this method, provision is made for embodying the switch as a transfer gate with special semiconductor transistors into which diodes for recording the chip temperature are integrated, and for controlling it in such a way by means of a charge pump, that the chip temperature of the transistors is regulated and can be limited to a predetermined nominal value.

Advantageously the predetermined nominal temperature lies in the operating range of the power semiconductor. On the one hand this prevents the power switch being operated above its permitted temperature and on the other hand, because it is operated in this way, prevents the lifetime of the power semiconductor being reduced.

Advantageous further developments of the invention can be taken from the subclaims.

An embodiment of the invention is explained below in greater detail on the basis of a schematic drawing. The drawings show:

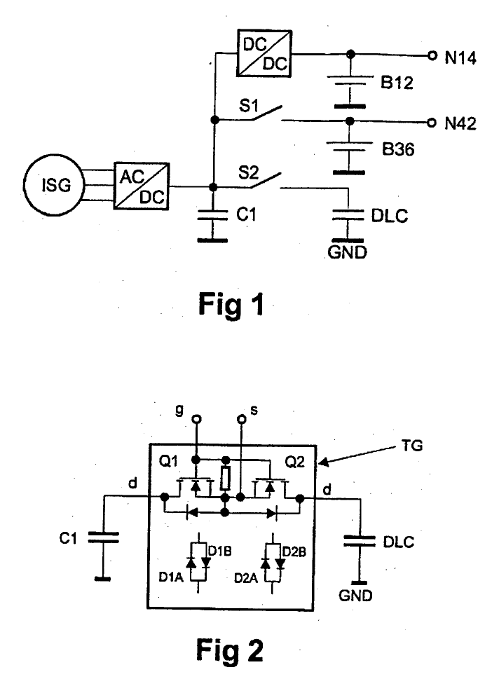

FIG. 1 a basic circuit diagram of a 14V/42V wiring system of a vehicle,

FIG. 2 a basic circuit diagram of a semiconductor power switch embodied as a transfer gate,

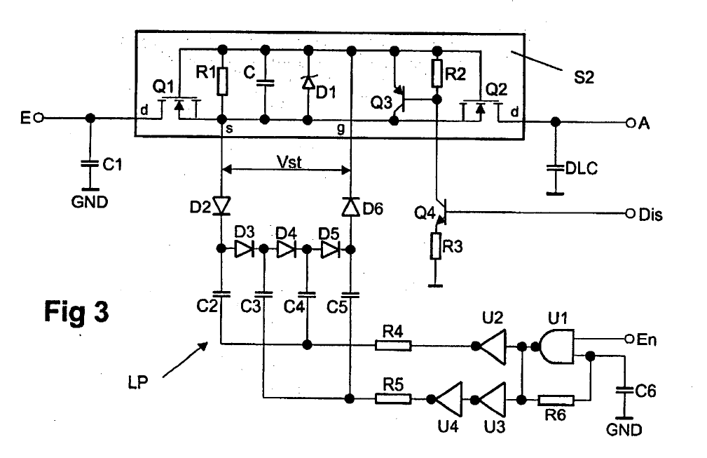

FIG. 3 the circuit of a transfer gate which can be controlled by means of a charge pump,

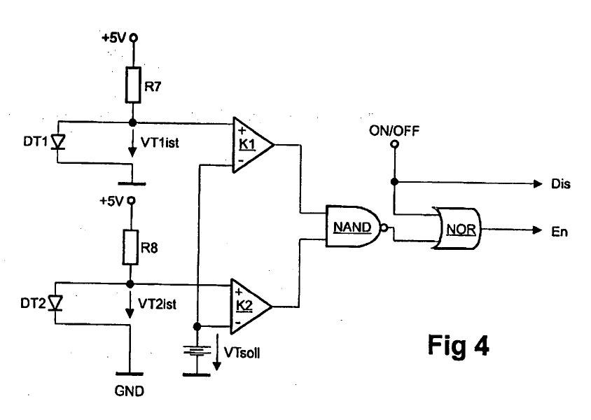

FIG. 4 a temperature recording device with nominal value comparison and logic gates.

FIG. 1 shows a basic circuit diagram of a 14V/42V wiring system of a vehicle with an integrated starter generator ISG connected to an internal combustion engine (not shown) on the basis of which the invention is explained in greater detail. This ISG is connected by means of a bidirectional AC/DC converter AC/DC
a) directly to an intermediate circuit capacitor C1,
b) via a power switch S2 to a double layer capacitor DLC,
c) via a power switch S1 to a 36V accumulator B36 and a 42V wiring system of a vehicle, and
d) via a bidirectional DC/DC converter DC/DC to a 12V accumulator B12 and a 14V wiring system of a vehicle N14.
   According to the invention, in accordance with a program which is not explained in further detail, each power switch (S1 and S2) should be embodied as a transfer gate which is controlled by a charge pump actuated by the commands from a control unit which is not shown.

FIG. 2 is a basic circuit diagram of a switch embodied as a transfer gate TG, for example, for the switch S2 which is arranged between the intermediate circuit capacitor C1 and the double layer capacitor DLC. If further switches other than the switches embodied as a transfer gate are required, these are embodied identically.

The transfer gate TG consists of two MOSFET transistors Q1 and Q2 connected in series whose source connections s and gate connections g are interconnected in each case. The drain connections d serve as input E or output A of the switch. Because in the wiring system of a vehicle, the voltage differences Vdiff and the current directions at the switch can have any leading sign or any direction, two transistors or groups of transistors connected in series must be used, of blocked state of the power switch. Such an arrangement is known as the transfer gate, which performs the actual switching function.

Such a switch embodied as a transfer gate is controlled by applying a control voltage between the source connection and the gate connection. In order to reduce the control voltage, a resistor not described in greater detail in this case is provided between the gate and the source connection.

There is provision in accordance with the invention, as indicated in FIG. 2, for using commercially-available transistors with integrated temperature sensors (D1A, D1B, D2A and D2b) in the transfer gate as semiconductors Q1 and Q2, which are known for example from the “Philips Semiconductors Product Specification, Power MOS transistor voltage clamped logic level FET with temperature sensing diodes, BUK9120-48TC, February 1998*. On the manufacturer side two antiparallel diodes are integrated to record the chip temperatures for each PowerMOSFET, however in the exemplary embodiment in accordance with the invention only one diode is used per PowerMOSFET Q1, Q2.

In FIG. 3, the circuit of switch S2 embodied as a transfer gate which can be controlled by a charge pump, said circuit being arranged between the intermediate circuit capacitor C1 and the double layer capacitor DLC, is shown once more, but without the integrated temperature sensor. In addition, it is possible that by means of a signal Dis via a further transistor Q3 arranged in the transfer gate (and an external transistor Q4), the control voltage can be short-circuited in order to open the transfer gate quickly (to make it non-conductive).

The charge pump LP known per se (capacitors C2 to C5 and diodes D3 to D5) sets up a control voltage between the source connection and the gate connection s, g of the transfer gate (switch 2). It is supplied by a gate oscillator (logical circuit elements U1 up to U4) having an enable function. In this way, both the oscillator and the charge pump LP can be enabled and disabled by a logical control signal En (enable). The generation of this control signal En is explained further below.

By enabling the charge pump LP by means of a signal En (enable), a positive control voltage is set up between the source connection and the gate connection as a result of which switch S2 (transfer gate) accordingly becomes conductive. After the disabling process, this voltage is again reduced as a result of which switch S2 again becomes non-conductive. The enabling and disabling takes place controlled in time, i.e. by means of explicitly enabling and disabling the charge pump, the transfer gate can be kept in an similar conductive state.

FIG. 4 shows the inventive circuit for recording the chip temperatures of transistors Q1 and Q2 of the transfer gate TG with nominal comparison and logical signal combination.

This temperature recording unit consists for each transistor Q1, Q2, of a series circuit at the poles of a voltage source (which can be an existing 5V supply), consisting of a resistor R7, R8 and the temperature-sensitive diode DT1, DT2 (which corresponds to the diode D1B, D2B in FIG. 2), which causes a working current of 1 mA to flow through the diodes DT1, DT2.

The connection point between resistor R7 and diode DT1, or resistor R8 and diode DT2, is linked in each case to the non-inverting input of a comparator K1 or K2, at the inverting input of which lies a nominal voltage VTsoll assigned to a nominal temperature Tsoll. The outputs of the two comparators K1, K2 are connected to the inputs of a first logic element NAND, of which the output is connected to the input of a second logic element NOR, to the other input of which an ON/OFF signal is fed, which will be discussed in more detail below. The enable signal En, which is fed to the gate oscillator of the charge pump. appears at the output of the second logic element NOR. The diodes DT1, DT2 for recording the chip temperatures have a negative temperature coefficient, i.e. as the chip temperature increases the flux voltage reduces monotonously at around 1.6 mV/° C. The value of the flux voltage at 25° C. is 660 mV for example.

As a result of the structure of the transfer gate one transistor is operated with reverse polarity in each case (drain-source voltage), whereas the other carries the major part of the switch voltage. The chip temperatures also develop in a correspondingly different way during the switch-on process. It is thus necessary to record the temperatures of the transistors Q1, Q2 separately and to align the regulation to the higher temperature in each case.

The following information can be taken from the tables shown below (in which high=H and low=L; an underscored reference signal means that the signal at its output is meant):

| | | | | | | | | C | | |
|---|---|---|---|---|---|---|---|---|---|---|
| | | | | | | | | | ON/OFF | |
| | | | | | | | | | ON = L | |
| A | | | | B | | | | | OFF = H | NOR |
| | K1 | K2 | | K1 | K2 | NAND | | NAND | Dis | En |
| VT1ist > VTsoll | H | — | → | L | L | H | → | L | L | H |
| VT1ist < VTsoll | L | — | | L | H | H | | H | L | L |
| VT2ist > VTsoll | — | H | | H | L | H | | L | H | L |
| VT2ist < VTsoll | — | L | | H | H | L | | H | H | L |

Table A: Provided the diode voltage VT1ist, VT2ist generated by the relevant chip temperature T1ist, T2ist is greater than a predetermined nominal voltage value VTsoll assigned to an increased but permitted chip temperature Tsoll, the output of the assigned comparator K1, K2 is at a high signal.

Table B: As soon as the diode voltage VT1ist, VT2ist assigned to the relevant chip temperature T1ist, T2ist falls below the predetermined nominal voltage value VTsoll, the output of the assigned comparator K1, K2 goes to a low signal and the output signal of the first logic element NAND jumps to a high signal. Table C: If the output signal of the first logic element NAND goes to a high signal, the output signal of the second logic element NOR which follows it (enable signal En) jumps to a low signal, whereby the charge pump LP stops and the transfer gate becomes non-conducting.

An ON/OFF signal can be taken from FIG. 4 and Table C. This already mentioned signal is a command of the control device which is not shown in the Figure. It is always ON=low if the associated switch S1, S2 is to be conducting and is OFF=high if this switch is to be non-conducting.

This ON/OFF signal is identical to the signal Dis in FIG. 3, which rapidly makes the switch S1, S2 non-conducting by short-circuiting the gate-source path and holds it in this state for as long as OFF=high.

It can also be seen from Table C that the charge pump LP can only make the switch conducting if on the one hand the control device for it gives its permission (ON=Dis=low) and if on the other hand the output signal of the first logic element NAND signals by its low state that no chip temperature has exceeded the nominal value. The output signal En of the second logic element NOR then goes to a high level and the subsequent gate oscillator (U1 to U4, FIG. 3) creates a rising gate voltage for the transfer gate Q1, Q2 which conducts noticeably more strongly. The current through Q1, Q2 thereby increases and thus the power dissipation and the chip temperature as well, at which point the flux voltage of the temperature-sensitive diodes DT1 and DT2 falls. This goes on until the VT1ist or VT2ist falls below the value VTsoll. Enable signal En goes to low and the oscillator stops. The charge pump LP no longer delivers any gate voltage=control voltage Vst and capacitor C1 discharges itself through resistor R1, which causes the gate voltage to fall slowly. The transfer gate becomes more non-conductive, the power dissipations of the transistors Q1 and Q2 fall and thereby also the chip temperatures, at which point the flux voltages of the diodes DT1 and DT2 rise again and the process starts over.

Overall this produces a two-state controller of which the oscillator frequency and amplitude depend on the delay times of the control elements.

1-4. (canceled)

5. A method for switching a semiconductor power switch, which comprises the following steps:
providing a semiconductor power switch with a switching path having a resistance and a control input;
controlling the resistance of the switching path of the semiconductor power switch via the control input by at least one of a control voltage and a control current in dependence on a chip temperature to maintain the chip temperature of the power switch at a predetermined setpoint temperature, and thereby increasing the resistance of the switching path when the setpoint temperature is reached.

6. A device for driving a semiconductor power switch connected between two energy storage devices in a wiring system of a vehicle equipped with an integrated starter generator, comprising:
a semiconductor power switch having a switching path, and a control input for controlling said power switch with a control voltage Vst as a transfer gate to a non-conductive off-state or to a conductive on-state;
said power switch having two transistors or groups of transistors connected in series, wherein, in an off-state of said power switch, at least one of said two transistors or groups of transistors is blocked;
at least one diode assigned to each transistor or group of transistors for recording a chip temperature;
a charge pump for generating the control voltage, said charge pump driving said transistors of said power switch, in the conductive on-state, in each case only to such an extent that the chip temperature of each transistor of said power switch is maintained at a predetermined setpoint temperature; and
a temperature recording unit configured to compare the chip temperature with the predetermined setpoint temperature and to output an enable signal representing a result of the comparison to said charge pump, and wherein a resistance of said switching path is increased when the setpoint temperature is reached.

7. The device according to claim 6, wherein said two transistors or group of transistors have interconnected gate terminals and interconnected source terminals, and which comprises a further transistor connected to said transfer gate, said further transistor having a collector-emitter path between said interconnected gate connections and said interconnected source connections of two transistors or groups of transistors, said further transistor being connected to receive an external signal for switching into a conductive state and for rapidly rendering said transfer gate non-conductive.

8. The device according to claim 6, wherein:
said temperature recording unit including at least one series circuit, connected to poles of a voltage source, and comprising said respectively assigned diode, and a resistor for each transistor or group of transistors, wherein a node between said resistor and said diode, at which a voltage representing the chip temperature is present;
which further comprises a plurality of comparators each having a first input connected to a respective said node between said resistor and said diode, a second input receiving a nominal voltage representing the setpoint temperature, and an output;
said comparators performing a comparison between the voltage representing the chip temperature and the nominal voltage representing the setpoint temperature;
which further comprises a first logic element having an input connected to said outputs of said comparators, and an output;
a second logic element having a first input connected to said output of said first logic element, a second input connected to receive an ON/OFF signal, and an output outputting an output signal; and
said output of said second logic element connected to a gate oscillator of said charge pump as an enable signal.
